(19) United States
(12) Patent Application Publication
(10) Pub. No.: US 2021/0144992 A1
(43) Pub. Date: May 20, 2021

(54) OIL-BASED SUSPENSION CONCENTRATES

(71) Applicant: Bayer CropScience Aktiengesellschaft, Monheim am Rhein (DE)

(72) Inventors: Reiner FISCHER, Monheim (DE); Oliver GAERTZEN, Koeln (DE); Leonardo PITTA, Leverkusen (DE); Rolf PONTZEN, Leichlingen (DE); Udo RECKMANN, Hanau (DE); Arnoldus VERMEER, Monheim (DE)

(21) Appl. No.: 17/046,909

(22) PCT Filed: Apr. 12, 2019
(86) PCT No.: PCT/EP2019/059445

§ 371 Date: Oct. 12, 2020

(30) Foreign Application Priority Data
Apr. 13, 2018 (EP) 18167223.9

(51) Int. Cl. A01N 25/04; A01N 43/90; A01N 25/30

(52) U.S. Cl. CPC A01N 25/04; A01N 25/30; A01N 43/90

(57) ABSTRACT

Novel oil-based suspension concentrates consisting of
at least one room temperature-solid compound of the formula (I),
at least one suspended ammonium salt of the formula (1),
at least one mineral oil, vegetable oil, fatty acid triglyceride or fatty acid alkyl ester,
at least one nonionic surfactant and/or at least one anionic surfactant,
optionally an uptake promoter, and optionally one or more additives from the groups of the spreaders, the foam inhibitors, the antioxidants, the dyes and/or the thickeners.
   a process for producing these suspension concentrates and the use thereof for application of the active ingredients present.

The invention relates to novel, oil-based suspension concentrates of cyclic ketoenols, to a process for producing these formulations and to the use thereof for application of the cyclic ketoenols present for control of animal pests.

To display biological efficacy, systemic active agrochemical ingredients, especially systemic insecticides, need a formulation which enables uptake of the active ingredients into the plant/the target organisms. Typically, systemic active agrochemical ingredients are therefore formulated as an emulsion concentrate (EC), soluble liquid (SL) and/or adjuvanted suspension concentrate (SC) or oil-based suspension concentrate (OD). In an EC and SL formulation, the active ingredient is in dissolved form, and in an SC and OD formulation in solid form. While the active ingredient in dissolved form satisfies the best prerequisites for uptake into the plant or the target organisms, biological efficacy in adjuvanted SC and OD formulations is increased by adding penetrants. As well as these penetrants, further adjuvants that improve the properties (retention, spreading characteristics, rain resistance, etc.) are typically also incorporated into the formulation. An adjuvant in this context is a component which enhances the biological effect of the formulation, without the component itself showing any biological action. Adjuvants in general and penetrants in particular are surfactants that can come from various chemical classes (e.g. alkanol ethoxylates, amino ethoxylates, or esters of vegetable oils (e.g. MSO)).

The use of a wide variety of different oils for improving the effectiveness of pesticides by improving the wetting and distribution characteristics of the spray residues is described. Examples of these oils are mineral oils, vegetable oils and esters of these vegetable oils. It is known that vegetable oil esters improve the uptake of many pesticides into the leaf and that the very low volatility of vegetable oils, for example, enhances the residual effectiveness of crop protection compositions.

Numerous oil-based suspension concentrates of active agrochemical ingredients are already known. For instance, EP-A 0 789 999 describes formulations of this type which, as well as active ingredient and oil, contain a mixture of various surfactants, including those that serve as penetrants, and a hydrophobized sheet aluminosilicate as thickener. The stability of these formulations is good. Furthermore, U.S. Pat. No. 6,165,940 already discloses oil-based suspension concentrations in which, apart from active agrochemical ingredient, penetrant and surfactant or surfactant mixture, there is also an organic solvent present, where useful solvents of this kind also include paraffin oil or vegetable oil esters. However, crop plant compatibility and/or biological efficacy and/or stability of the spray liquors producible from these formulations by diluting with water is not always satisfactory.

WO 05/084435 and WO 05/08441 describe oil-based suspension concentrates containing a penetrant in addition to cyclic ketoenols and oil.

U.S. Pat. No. 6,423,667 discloses oil-based suspension concentrates containing ammonium sulfate and a nonionic surfactant that are used as herbicidal auxiliaries or as herbicidal compositions.

As well as these oils, there is a further group of adjuvants: that of the ammonium salts. In many of the compositions described in the prior art, ammonium ions are included in the formulations because the active ingredients used are used in the form of ammonium salts, as is customary particularly in the case of the widely used herbicide glyphosate (e.g. WO 07/050090, WO 05/117583, WO 05/013692, WO 06/050141, US 2003/104947, U.S. Pat. No. 5,238,604, DE-A-197 52 552). In the present invention, however, a separate ammonium salt is added. The literature already says that the action of various active ingredients can be enhanced by addition of ammonium salts. However, these are salts which act as detergents (for example WO 95/017817) or salts having relatively long-chain alkyl and/or aryl substituents that have permeabilizing action or increase the solubility of the active ingredient (for example EP-A 0 453 086, EP-A 0 664 081, FR-A 2 600 494, U.S. Pat. Nos. 4,844,734, 5,462,912, 5,538,937, US-A 03/0224939, US-A 05/0009880, US-A 05/0096386). Furthermore, the prior art describes efficacy only for particular active ingredients and/or particular uses of the corresponding compositions. In yet other cases, these are salts of sulfonic acids, where the acids for their part have a paralyzing effect on insects (U.S. Pat. No. 2,842,476). An enhancement of action by ammonium sulfate, for example, is described, for example, for the herbicides glyphosate and phosphinothricin (U.S. Pat. No. 6,645,914, EP-A 0 036 106).

There have also been descriptions of the use of ammonium sulfate as formulation auxiliary for particular active ingredients and applications (WO 92/16108), but its function therein is to stabilize the formulation, not to enhance the action. Also known are tankmix compositions of cyclic ketoenols with ammonium salts for enhancing the action, for example in WO 07/068427, WO 07/068428 and WO 08/067911.

The adjuvants described can be incorporated into the formulation of the active agrochemical ingredient (in-can formulation) or added to the spray liquor after dilution of the concentrated formulation (tankmix) To prevent dosage errors and to improve user safety in the application of agrochemical products, it is advantageous to incorporate the additives into the formulation. In addition, this avoids the unnecessary use of additional packaging material for the tankmix products. The above-described compositions contain either an oil/penetrant system or an ammonium salt to enhance the biological action. However, there has been no description to date of the combination of both adjuvants in an “in-can” formulation containing active agrochemical ingredients.

There is no possibility of incorporating active agrochemical ingredients, ammonium salts and uptake-promoting auxiliaries in an “in-can” EC formulation (i.e. concentrated ready-to-use formulation) without formulation-related problems because the solubility of the ammonium salts in nonpolar solvents is extremely low. The main reason for this is that aqueous and water-based “in-can” mixtures (SL and SC) containing active agrochemical ingredients, ammonium salts and uptake-promoting auxiliaries is technically problematic. This is attributable to the poor physical stability of such mixtures. But for few exceptions, the uptake promoters flocculate as a result of the high salt concentrations necessary.

The use of oils as uptake promoter in combination with ammonium salts for agrochemical compositions, possibly mixed with further uptake-promoting surfactants, would be a logical alternative. However, as mentioned above, the only adjuvant compositions known in the literature are for the most part those that contain either oil(s) or ammonium salts. One of the difficulties in the development of such formulations is the presentation form of the ammonium salt. In aqueous adjuvant compositions, the ammonium salts are usually in dissolved form, resulting in a homogeneous liquid formulation. In the various oils that are useful for improving the effectiveness of pesticides, the solubility of the suitable ammonium salts is considerably lower than the amount of salt needed to enhance the action. Accordingly, the ammonium salt will be in crystalline form in the oil-based formulations, which causes formulation-related problems. For example, the standard ammonium salts are difficult to comminute owing to their hardness. In addition, ammonium salt-containing, oil-based formulations after comminution tend to have high viscosities and are generally difficult to stabilize in oil-based suspension concentrates.

It is known that systemic insecticides in particular that are to be taken up into the plant or into the target organisms should preferably be present in the dissolved state either in the concentrate and/or in aqueous dilution for application. It is additionally known that organic substances have different water solubilities, and these water solubilities, according to chemical characteristics, may be pH-dependent. Particular compounds of the formula (I) that are solid at room temperature satisfy this profile.

The problem addressed was therefore that of providing stable, storage-stable, liquid agrochemical compositions which contains at least one oil useful for improving the action of cyclic ketoenols and a suitable ammonium salt having a small particle size distribution in a sufficient amount, and which provides the active ingredient in dissolved form either in a concentrate and/or in aqueous dilution.

It has now been found that, surprisingly, this object is achieved by the specific composition of the present invention.

The present invention thus relates to oil-based agrochemical compositions comprising
at least one room temperature-solid compound of the formula (I)

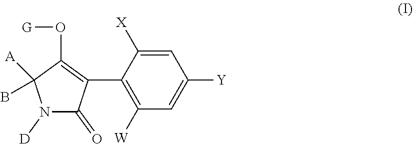

in which
W and Y are independently hydrogen, C₁-C₄-alkyl, chlorine, bromine, iodine or fluorine,
X is C₁-C₄-alkyl, C₁-C₄-alkoxy, chlorine, bromine or iodine,
D is hydrogen or methyl,
A, B and the carbon atom to which they are bonded are C₃-C₆-cycloalkyl in which one ring member has optionally been replaced by nitrogen and which is optionally monosubstituted by C₁-C₄-alkoxy,
A, B and the carbon atom to which they are bonded are C₃-C₆-cycloalkyl substituted by an optionally C₁-C₄-alkyl- or C₁-C₄-alkoxy-C₁-C₂-alkyl-substituted alkylenedioxy group that forms a 5-membered or 6-membered ketal together with the carbon atom to which it is bonded,
G is hydrogen (a) or is one of the groups

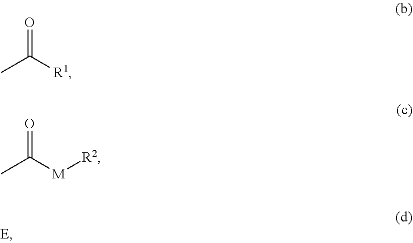

in which
E is a metal ion or an ammonium ion,
M is oxygen or sulfur,
R¹ is straight-chain or branched C₁-C₆-alkyl,
R² is straight-chain or branched C₁-C₆-alkyl
   and
   at least one suspended ammonium salt of the formula (1)

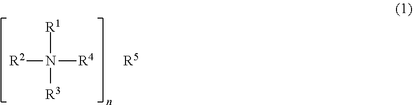

in which
R¹, R², R³ and R⁴ are independently hydrogen or in each case optionally mono- or polysubstituted C₁-C₈-alkyl or C₁-C₈-alkylene, where the substituents may be selected from halogen, nitro and cyano,
n is 1, 2 or 3,
R⁵ is hydrogencarbonate, tetraborate, fluoride, bromide, iodide, chloride, monohydrogenphosphate, dihydrogenphosphate, hydrogensulfate, tartrate, sulfate, nitrate, thiosulfate, thiocyanate, formate, lactate, acetate, propionate, butyrate, pentanoate, citrate, oxalate, carbonate, pentaborate, sulfite, benzoate, hydrogenoxalate, hydrogencitrate, methylsulfate or tetrafluoroborate,
at least one mineral oil, vegetable oil, fatty acid triglyceride or fatty acid alkyl ester,
at least one nonionic surfactant and/or at least one anionic surfactant,
optionally an uptake promoter, and
optionally one or more additives from the groups of the spreaders, the foam inhibitors, the antioxidants, the dyes and/or the thickeners.

The number n in the formula (1) results from the ionic charge of the substituent R⁵.

What is meant by “oil-based composition” is that the compositions according to the invention are largely free of water. The water content is preferably lower than 1.5% by weight, more preferably lower than 0.7% by weight. Owing to the low water content, the ammonium salt of the formula (1) is in suspended form in the compositions according to the invention.

The present invention further relates to processes for producing these agrochemical compositions and to the use thereof for improving the action of crop protection compositions.

It has additionally been found that the oil-based agrochemical compositions according to the invention can be produced by mixing
at least one room temperature-solid compound of the formula (I),
at least one ammonium salt of the formula (1),
at least one mineral oil, vegetable oil, fatty acid triglyceride or fatty acid alkyl ester, at least one nonionic surfactant and/or at least one anionic surfactant,
optionally an uptake promoter, and
optionally one or more additives from the groups of the spreaders, the foam inhibitors, the antioxidants, the dyes and/or the thickeners
   with one another, and then optionally grinding the resulting suspension.

Finally, it has been found that the oil-based suspension concentrates according to the invention are of very good suitability for application of the compounds of the formula (I) present to plants and/or their habitat. It has additionally been found that the oil-based suspension concentrates according to the invention are of very good suitability for controlling animal pests.

It can be described as being extremely surprising that the oil-based agrochemical compositions according to the invention have low viscosity and very good stability, and especially that, even after storage at varying temperature, no significant crystal growth of the active ingredient and/or of the ammonium salt is observed. It is also unexpected that they show much better biological efficacy than the spray liquor assembled by means of a tankmix. Moreover, the oil-based agrochemical compositions according to the invention, in terms of their activity, surprisingly also surpass analogous formulations which, as well as the other components, contain either only an ammonium salt or only an oil. Such a synergistic effect was unforeseeable on the basis of the prior art described above.

The oil-based agrochemical compositions according to the invention are also notable for a series of further advantages. For instance, the number of necessary “tankmix” components is reduced because multiple properties to be optimized are combined in the liquid agrochemical compositions according to the invention. The user therefore has no need to mix his active ingredients with further mixture components in the spray liquor. This has the advantage of avoiding dosage errors and of increasing user safety when using agrochemical compositions. Furthermore, this avoids the use of packaging material for multiple “tankmix” products. It is further advantageous that, in the diluting of the liquid agrochemical compositions according to the invention with water, the pH of the spray liquor is also controllable through the selection of the ammonium salt in the product. Finally, the oil-based agrochemical compositions according to the invention promote the biological efficacy of the active components of the formula (I) in the formulation, such that, by comparison with conventional formulations, either a higher efficacy is achieved or less active ingredient is required.

Preferred embodiments of the subject matter of the invention are described hereinafter.

Preference is given to oil-based oil suspension concentrates containing compounds of the formula (I) in which the radicals are defined as follows:
W is more preferably methyl,
X is more preferably chlorine or methyl (particularly methyl),
Y is more preferably chlorine, bromine or methyl,
D is more preferably hydrogen,
A, B and the carbon atom to which they are bonded are more preferably saturated C₆-cycloalkyl substituted by an alkylenedioxy group that forms a 5-membered or 6-membered ketal together with the carbon atom to which it is bonded,
G is more preferably hydrogen (a) or is one of the groups

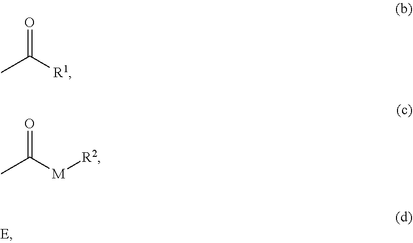

in which
M is oxygen,
E is one metal ion equivalent or an ammonium ion (specifically sodium or potassium),
R¹ is more preferably straight-chain or branched C₁-C₄-alkyl,
R² is more preferably straight-chain or branched C₁-C₄-alkyl.

Specific preference is given to the compounds of the formula (I) with G=hydrogen.

Unless indicated otherwise, optionally substituted radicals may be mono- or polysubstituted, where the substituents in the case of poly substitutions may be the same or different.

Especially preferred are compounds of the abovementioned formula (I) in which the radicals are as defined below:

(I)

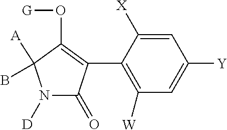

| | | | | | | | | |
|---|---|---|---|---|---|---|---|---|
| | | | | | | | | Known for |
| | | | | | | | | WO 06/ |
| | | | | | | | | 089633; |
| Ex. no. | W | X | Y | A | B | G | D | Ex. no. |

| | | | | | | | |
|---|---|---|---|---|---|---|---|
| I-1 | CH₃ | CH₃ | CH₃ | 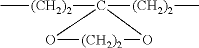 | H | H | I-1-a-2 |
| I-2 | CH₃ | CH₃ | Cl | 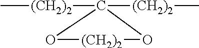 | H | H | I-1-a-4 |
| I-3 | CH₃ | CH₃ | Br | 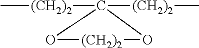 | H | H | I-1-a-26 |
| I-4 | CH₃ | CH₃ | CH₃ | 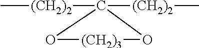 | H | H | I-1-a-18 |
| I-5 | CH₃ | CH₃ | Cl | 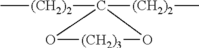 | H | H | I-1-a-14 |
| I-6 | CH₃ | CH₃ | Br | 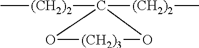 | H | H | I-1-a-19 |

Ammonium salts according to the invention are defined by formula (1)

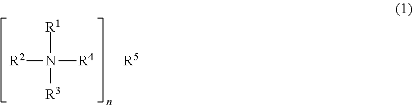

in which
R¹, R², R³ and R⁴ are independently hydrogen or in each case optionally mono- or polysubstituted C₁-C₈-alkyl or C₁-C₈-alkylene, where the substituents may be selected from halogen, nitro and cyano,
R¹, R², R³ and R⁴ are preferably independently hydrogen or in each case optionally monosubstituted C₁-C₄-alkyl, where the substituents may be selected from halogen, nitro and cyano,
R¹, R², Wand R⁴ are more preferably independently hydrogen, methyl, ethyl, n-propyl, isopropyl, n-butyl, isobutyl, s-butyl or t-butyl,
R¹, R², R³ and R⁴ are most preferably hydrogen,
R¹, R², R³ and R⁴ are additionally most preferably simultaneously methyl or simultaneously ethyl,
n is 1, 2 or 3,
n is preferably 1 or 2,
R⁵ is hydrogencarbonate, tetraborate, fluoride, bromide, iodide, chloride, monohydrogenphosphate, dihydrogenphosphate, hydrogensulfate, tartrate, sulfate, nitrate, thiosulfate, thiocyanate, formate, lactate, acetate, propionate, butyrate, pentanoate, citrate, oxalate, carbonate, pentaborate, sulfite, benzoate, hydrogenoxalate, hydrogencitrate, methylsulfate or tetrafluoroborate,
R⁵ is preferably lactate, sulfate, nitrate, thiosulfate, thiocyanate, citrate, oxalate, formate, monohydrogenphosphate or dihydrogenphosphate,
R⁵ is more preferably sulfate, monohydrogenphosphate or dihydrogenphosphate.

Preferred salts are ammonium hydrogencarbonate, ammonium tetraborate, ammonium fluoride, ammonium bromide, ammonium iodide, ammonium chloride, diammonium monohydrogenphosphate, ammonium dihydrogenphosphate, ammonium hydrogensulfate, ammonium tartrate, ammonium sulfate, ammonium nitrate, ammonium thiosulfate, ammonium thiocyanate, ammonium formate, ammonium lactate, ammonium acetate, ammonium propionate, ammonium butyrate, ammonium pentanoate, ammonium citrate, ammonium oxalate, ammonium carbonate, ammonium pentaborate, ammonium sulfite, ammonium benzoate, ammonium hydrogenoxalate, ammonium hydrogencitrate, ammonium methylsulfate or ammonium tetrafluoroborate.

Particularly preferred salts are diammonium monohydrogenphosphate, ammonium dihydrogenphosphate, ammonium sulfate, ammonium nitrate, ammonium thiosulfate, ammonium thiocyanate, ammonium formate, ammonium lactate, ammonium citrate or ammonium oxalate.

Particularly preferred salts are diammonium monohydrogenphosphate, ammonium dihydrogenphosphate and ammonium sulfate. Specific examples are diammonium monohydrogenphosphate (diammonium hydrogenphosphate) and ammonium sulfate.

The vegetable oils present in the adjuvant compositions according to the invention are commonly known and commercially available. The term “vegetable oils” or “fatty acid triglycerides” is understood to mean, for example, oils from oil-yielding plant species such as soybean oil, rapeseed oil, corn germ oil, corn kernel oil, sunflower oil, cottonseed oil, linseed oil, copra oil, palm oil, safflower oil, walnut oil, groundnut oil, olive oil, castor oil, colza oil, palm kernel oil, coconut oil and especially soybean oil, rapeseed oil, corn germ oil or sunflower oil and mixtures thereof. Furthermore, suitable triglycerides can be prepared synthetically by known methods, by reaction of glycerol with fatty acids or fatty acid derivatives. Triglycerides of this type are likewise commonly known and commercially available. The vegetable oils or triglycerides are preferably esters of C₈-C₂₂ fatty acids of glycerol. The C₈-C₂₂ fatty acid esters of glycerol are, for example, esters of unsaturated or saturated C₈-C₂₀ fatty acids, especially having an even number of carbon atoms, for example caprylic acid, capric acid, lauric acid, myristic acid, palmitic acid, erucic acid and especially C₁₈ fatty acid such as stearic acid, oleic acid, linoleic acid or linolenic acid. Specific examples are caprylic acid/capric acid triglycerides (Mitlyol 812 N® (Sasol, Germany)).

Useful mineral oils include various commercially available distillation fractions of mineral oil (petroleum) and paraffin oils. Preference is given to mixtures of open-chain C₁₄-C₃₀ hydrocarbons, closed-chain hydrocarbons (naphthenes) and aromatic hydrocarbons. The hydrocarbons may be either linear or branched. Particular preference is given to mixtures displaying an aromatic content of less than 8% by weight. Very particular preference is given to mixtures displaying an aromatic content of less than 4% by weight. Useful paraffin oils include linear and branched C₁₄-C₃₀ hydrocarbons. Paraffin oils are also known as base oil or white oil and are commercially available as Bayol® 85 (Exxon Mobil, Machelen, Belgium), Marcol® 82 (Exxon Mobil, Machelen, Belgium), BAR 0020 (RA.M.oil S.p.A., Naples, Italy), Pionier 0032-20 (Hansen & Rosenthal K G, Hamburg, Germany) or, for example, Kristol M14 (Carless, Surrey, England).

Useful fatty acid esters include alkyl fatty acid esters such as C₁-C₂₀-alkyl C₁₀-C₂₂ fatty acid esters. Preference is given to methyl esters, ethyl esters, propyl esters, butyl esters, 2-ethylhexyl esters and dodecyl esters. Particular preference is given to methyl esters and ethyl esters. Examples of synthetic fatty acid esters are, for example, those that derive from fatty acids having an odd number of carbon atoms, such as C₁₁-C₂₁ fatty acid esters. Said fatty acid esters can be prepared, for example, by transesterification by known methods, as described, for example, in Rompp Chemie Lexikon, 9th edition, volume 2, page 1343, Thieme Verlag Stuttgart.

The fatty acid esters can be present in the adjuvant compositions according to the invention in the form of commercially available esters, especially esters such as rapeseed oil methyl esters, e.g. Edenor® MESU (Cognis, Germany) or the Agnique® ME series (Cognis, Germany) or in the form of commercially available oil-containing formulation additives, especially those based on rapeseed oil methyl or ethyl esters, e.g. Hasten® (Victoria Chemicals, Australia), Actirob® B (Novance, France) or Stefes Mero® (Stefes, Germany). Specifically present is rapeseed oil methyl ester.

Specific examples are rapeseed oil methyl ester and caprylic acid/capric acid triglyceride.

Useful nonionic surfactants and/or dispersing auxiliaries include all substances of this type typically usable in agrochemical compositions. Preferred examples include reaction products of linear or branched alcohols with ethylene oxide and/or propylene oxide, reaction products of fatty acids with ethylene oxide and/or propylene oxide, reaction products of alkylphenols and/or arylalkylphenols with ethylene oxide and/or propylene oxide, for example ethoxylated nonylphenols, and likewise sorbitan derivatives, for example sorbitan fatty acid esters and ethoxylated sorbitan fatty acid esters, and also alkyl polyglycosides, taurides, and ethoxylated vegetable oils, for example ethoxylated soybean oil, and also castor oil ethoxylates. Other examples include polyethylene oxide-poly propylene oxide block copolymers, polyvinyl alcohol, polyvinylpyrrolidone, copolymers of polyvinyl alcohol and polyvinylpyrrolidone, and copolymers of (meth)acrylic acid and (meth)acrylic esters. Some of the substance classes mentioned above may optionally have been sulfated or phosphated and neutralized with bases.

Specific examples are ethoxylated vegetable oils and castor oils, phosphated and neutralized alkyl ethoxylates, ethoxylated sorbitan fatty acid esters.

Useful anionic surfactants or dispersing auxiliaries include all substances of this type typically usable in agrochemical compositions. Preference is given to alkali metal, alkaline earth metal and ammonium salts of alkylsulfonic acids, alkylarylsulfonic acids, alkyl sulfates or alkylaryl sulfates. A further preferred group is that of alkali metal, alkaline earth metal and ammonium salts of sulfated or phosphated alkylphenol ethoxylates or ethoxy propoxylates, for example calcium dodecylbenzenesulfonate/CaDBS, arylalkylphenol ethoxylates or ethoxy propoxylates or linear or branched alcohol ethoxylates or ethoxy propoxylates.

Other examples include salts of polystyrenesulfonic acids, salts of polyvinylsulfonic acids, salts of maleic acid-2,4,4-trimethylpentene copolymers, for example Geropon T36, salts of naphthalenesulfonic acid-formaldehyde condensation products, for example Morwet D-425, salts of condensation products of naphthalenesulfonic acid, phenolsulfonic acid and formaldehyde, and salts of lignosulfonic acids.

Specific examples are salts of sulfated alkylphenols, salts of naphthalenesulfonic acid-formaldehyde condensation products, salts of lignosulfonic acids.

Useful uptake promoters in the present context are all those substances which are typically used to improve the penetration of active agrochemical ingredients into plants. Uptake promoters are defined in this context by their ability to penetrate from the aqueous spray liquor and/or from the spray coating into the cuticle of the plant and hence increase the mobility of active ingredients in the cuticle. The method described hereafter and in the literature (Baur et al., 1997, Pesticide Science 51, 131-152) can be used to determine this property.

Useful uptake promoters include, for example, alkanol alkoxylates. Uptake promoters according to the invention are alkanol alkoxylates of the formula

R—O—(-AO)ₘ₋R′ (II)

in which
R is straight-chain or branched alkyl having 4 to 20 carbon atoms,
R′ is hydrogen, methyl, ethyl, n-propyl, isopropyl, n-butyl, isobutyl, t-butyl, n-pentyl or n-hexyl,

AO represents an ethylene oxide radical, a propylene oxide radical, a butylene oxide radical or mixtures of ethylene oxide and propylene oxide radicals or butylene oxide radicals and

m represents numbers from 2 to 30.

A preferred group of uptake promoters is that of alkanol alkoxylates of the formula

R—O—(-EO—)_{b}—R′ (II-a)

in which
R is as defined above,
R′ is as defined above,
EO is —CH₂—CH₂—O— and
b represents numbers from 2 to 20.

A further preferred group of uptake promoters is that of alkanol alkoxylates of the formula

R—O—(-EO—)ₚ—(—PO—)_{q}—R′ (II-b), and

R—O—(—PO—)_{q}-(EO—)ₚ—R′ (II-c)

in which
R is as defined above,
R′ is as defined above,
EO is —CH₂—CH₂—O—,

### PO is

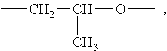

p represents numbers from 1 to 10 and
q represents numbers from 1 to 10.

A further preferred group of uptake promoters is that of alkanol alkoxylates of the formula

R—O—(-EO—)ᵥ—(—BO—)ₓ—R′ (II-d), and

R—O—(—BO—)ₓ—(-EO—)ᵥ—R′ (II-e)

in which
R and R′ have the definitions given above,
EO is CH₂—CH₂—O—,

### BO is

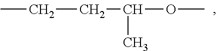

v represents numbers from 1 to 10 and
x represents numbers from 1 to 10.

In the formulae given above,
R is preferably butyl, isobutyl, n-pentyl, isopentyl, neopentyl, n-hexyl, isohexyl, n-octyl, isooctyl, 2-ethylhexyl, nonyl, isononyl, decyl, n-dodecyl, isododecyl, lauryl, myristyl, isotridecyl, trimethylnonyl, palmityl, stearyl or eicosyl.

The above formulae provide general definitions of the alkanol alkoxylates. These substances are mixtures of substances of the stated type with different chain lengths. The indices are therefore average values which may also deviate from whole numbers.

The alkanol alkoxylates of the stated formulae are known, and some of them are commercially available or can be prepared by known methods (cf. WO 98-35 553, WO 00-35 278 and EP-A 0 681 865).

Useful spreaders include all substances typically usable for this purpose in agrochemical compositions. Preference is given to alkylsiloxanes.

Useful foam inhibitors are all substances typically usable for this purpose in agrochemical compositions. Preference is given to silicone oils and magnesium stearate.

Suitable antioxidants are all substances which are typically usable for this purpose in agrochemical compositions. Preference is given to 2,6-di-tert-butyl-4-methylphenol.

Useful dyes are all substances typically usable for this purpose in agrochemical compositions. Examples include titanium dioxide, pigment black, zinc oxide and blue pigments, and also Permanent Red FGR.

Useful thickeners are all substances typically usable for this purpose in agrochemical compositions and function as thickening agents. Preference is given to inorganic particles such as carbonates, silicates and oxides, and also talc, and also organic substances such as urea-formaldehyde condensates. Examples include kaolin, rutile, silicon dioxide, what are called finely divided silicas, silica gels, and also natural and synthetic silicates such as attapulgites, bentonites, sepiolites, or montmorillonites, and organomodified derivatives thereof.

The content of the individual components in the agrochemical compositions according to the invention can be varied within a relatively wide range. Preference is given to compositions comprising
a) 0.5% to 20% by weight of the compound of the formula (I)
b) 5-35% by weight of ammonium salt of the formula (1)
c) 20-75% by weight of oil
d) 1-25% by weight of nonionic surfactant and/or anionic surfactant
e) 0-25% by weight of uptake promoter
f) 0-10% by weight of one or more additives from the groups of the foam inhibitors, the antioxidants, the spreaders, the dyes and/or a thickener.

Particular preference is given to compositions comprising
a) 1% to 15% by weight of the compound of the formula (I)
b) 15-30% by weight of ammonium salt of the formula (1)
c) 35-65% by weight of oil
d) 5-20% by weight of nonionic surfactant and/or anionic surfactant
e) 0-20% by weight of uptake promoter
f) 0-8% by weight of one or more additives from the groups of the foam inhibitors, the antioxidants, the spreaders, the dyes and/or a thickener.

The oil-based agrochemical compositions according to the invention are produced by mixing the components with one another in the respectively desired ratios. The sequence in which the constituents are combined with one another may be as desired. It is appropriate to use the solid components in the finely ground state. However, it is also possible to subject the suspension formed after the combination of the constituents first to a coarse and then to a fine grinding step, such that the mean particle size is below 20 μm. Preference is given to suspension concentrates in which the solid particles have an average particle size between 1 and 10 μm.

In the course of performance of the process according to the invention, the temperatures can be varied within a particular range. In general, working temperatures are between 10° C. and 60° C., preferably between 15° C. and 40° C.

Useful equipment for performance of the process according to the invention is customary mixing and grinding equipment which is used to prepare agrochemical formulations.

The oil-based agrochemical compositions according to the invention are formulations which remain stable even after prolonged storage at elevated temperatures or under cold conditions, since no crystal growth is observed. They can be converted to homogeneous spray liquids by diluting with water.

These spray liquids are applied by customary methods, i.e., for example, by spraying, pouring or injecting.

The application rate of the oil-based suspension concentrates according to the invention can be varied within a relatively wide range. It is guided by the active agrochemical ingredients in question and by the content thereof in the formulations.

With the aid of the oil-based suspension concentrates according to the invention, active agrochemical ingredients can be deployed in a particularly advantageous manner on plants and/or their habitat. The active agrochemical ingredients of the formula (I) present display better biological efficacy (especially better insecticidal and/or acaricidal action and/or better crop plant compatibility) than in the case of application in the form of the corresponding conventional formulations.

The compounds of the formula (I) can be employed in according to the invention on their own or else in combination with other active insecticidal and/or acaricidal ingredients and/or nematicides.

The compositions according to the invention, given good plant tolerance and favourable toxicity to warm-blooded animals and good environmental tolerance, are suitable for protecting plants and plant organs, for increasing the harvest yields, for improving the quality of the harvested material and for controlling animal pests, in particular insects, arachnids and nematodes, which are encountered in agriculture, in horticulture, in forests and in gardens and leisure facilities. They can preferably be used as pesticides. They are active against normally sensitive and resistant species and also against all or specific stages of development. The abovementioned pests include:

pests from the phylum of the Arthropoda, especially from the class of the Arachnida, for example Acarus spp., e.g. Acarus siro, Aceria kuko, Aceria sheldoni, Aculops spp., Aculus spp., e.g. Aculus fockeui, Aculus schlechtendali, Amblyomma spp., Amphitetranychus viennensis, Argas spp., Boophilus spp., Brevipalpus spp., e.g. Brevipalpus phoenicis, Bryobia graminum, Bryobia praetiosa, Centruroides spp., Chorioptes spp., Dermanyssus gallinae, Dermatophagoides pteronyssinus, Dermatophagoides farinae, Dermacentor spp., Eotetranychus spp., e.g. Eotetranychus hicoriae, Epitrimerus pyri, Eutetranychus spp., e.g. Eutetranychus banksi, Eriophyes spp., e.g. Eriophyes pyri, Glycyphagus domesticus, Halotydeus destructor, Hemitarsonemus spp., e.g. Hemitarsonemus latus (=Polyphagotarsonemus latus), Hyalomma spp., Ixodes spp., Latrodectus spp., Loxosceles spp., Neutrombicula autumnalis, Nuphersa spp., Oligonychus spp., e.g. Oligonychus coffeae, Oligonychus coniferarum, Oligonychus ilicis, Oligonychus indicus, Oligonychus mangiferus, Oligonychus pratensis, Oligonychus punicae, Oligonychus yothersi, Ornithodorus spp., Ornithonyssus spp., Panonychus spp., e.g. Panonychus citri (=Metatetranychus citri), Panonychus ulmi (=Metatetranychus ulmi), Phyllocoptruta oleivora, Platytetranychus multidigituli, Polyphagotarsonemus latus, Psoroptes spp., Rhipicephalus spp., Rhizoglyphus spp., Sarcoptes spp., Scorpio maurus, Steneotarsonemus spp., Steneotarsonemus spinki, Tarsonemus spp., e.g. Tarsonemus confusus, Tarsonemus pallidus, Tetranychus spp., e.g. Tetranychus canadensis, Tetranychus cinnabarinus, Tetranychus turkestani, Tetranychus urticae, Trombicula alfreddugesi, Vaejovis spp., Vasates lycopersici; from the order of the Coleoptera, for example Acalymma vittatum, Acanthoscelides obtectus, Adoretus spp., Aethina tumida, Agelastica alni, Agrilus spp., e.g. Agrilus planipennis, Agrilus coxalis, Agrilus bilineatus, Agrilus anxius, Agriotes spp., e.g. Agriotes linneatus, Agriotes mancus, Alphitobius diaperinus, Amphimallon solstitialis, Anobium punctatum, Anoplophora spp., e.g. Anoplophora glabripennis, Anthonomus spp., e.g. Anthonomus grandis, Anthrenus spp., Apion spp., Apogonia spp., Atomaria spp., e.g. Atomaria linearis, Attagenus spp., Baris caerulescens, Bruchidius obtectus, Bruchus spp., e.g. Bruchus pisorum, Bruchus rufimanus, Cassida spp., Cerotoma trifurcata, Ceutorrhynchus spp., e.g. Ceutorrhynchus assimilis, Ceutorrhynchus quadridens, Ceutorrhynchus rapae, Chaetocnema spp., e.g. Chaetocnema confinis, Chaetocnema denticulata, Chaetocnema ectypa, Cleonus mendicus, Conoderus spp., Cosmopolites spp., e.g. Cosmopolites sordidus, Costelytra zealandica, Ctenicera spp., Curculio spp., e.g. Curculio caryae, Curculio caryatrypes, Curculio obtusus, Curculio sayi, Cryptolestes ferrugineus, Cryptolestes pusillus, Cryptorhynchus lapathi, Cryptorhynchus mangiferae, Cylindrocopturus spp., Cylindrocopturus adspersus, Cylindrocopturus furnissi, Dendroctonus spp., e.g. Dendroctonus ponderosae, Dermestes spp., Diabrotica spp., e.g. Diabrotica balteata, Diabrotica barberi, Diabrotica undecimpunctata howardi, Diabrotica undecimpunctata undecimpunctata, Diabrotica virgifera virgifera, Diabrotica virgifera zeae, Dichocrocis spp., Dicladispa armigera, Diloboderus spp., Epicaerus spp., Epilachna spp., e.g. Epilachna borealis, Epilachna varivestis, Epitrix spp., e.g. Epitrix cucumeris, Epitrix fuscula, Epitrix hirtipennis, Epitrix subcrinita, Epitrix tuberis, Faustinus spp., Gibbium psylloides, Gnathocerus cornutus, Hellula undalis, Heteronychus arator, Heteronyx spp., Hylamorpha elegans, Hylotrupes bajulus, Hypera postica, Hypomeces squamosus, Hypothenemus spp., e.g. Hypothenemus hampei, Hypothenemus obscurus, Hypothenemus pubescens, Lachnosterna consanguinea, Lasioderma serricorne, Latheticus oryzae, Lathridius spp., Lema spp., Leptinotarsa decemlineata, Leucoptera spp., e.g. Leucoptera coffeella, Limonius ectypus, Lissorhoptrus oryzophilus, Listronotus (=Hyperodes) spp., Lixus spp., Luperodes spp., Luperomorpha xanthodera, Lyctus spp., Megacyllene spp., e.g. Megacyllene robiniae, Megascelis spp., Melanotus spp., e.g. Melanotus longulus oregonensis, Meligethes aeneus, Melolontha spp., e.g. Melolontha melolontha, Migdolus spp., Monochamus spp., Naupactus xanthographus, Necrobia spp., Neogalerucella spp., Niptus hololeucus, Oryctes rhinoceros, Oryzaephilus surinamensis, Oryzaphagus oryzae, Otiorhynchus spp., e.g. Otiorhynchus cribricollis, Otiorhynchus ligustici, Otiorhynchus ovatus, Otiorhynchus rugosostriarus, Otiorhynchus sulcatus, Oulema spp., e.g. Oulema melanopus, Oulema oryzae, Oxycetonia jucunda, Phaedon cochleariae, Phyllophaga spp., Phyllophaga helleri, Phyllotreta spp., e.g. Phyllotreta armoraciae, Phyllotreta pusilla, Phyllotreta ramosa, Phyllotreta striolata, Popillia japonica, Premnotrypes spp., Prostephanus truncatus, Psylliodes spp., e.g. Psylliodes affinis, Psylliodes chrysocephala, Psylliodes punctulata, Ptinus spp., Rhizobius ventralis, Rhizopertha dominica, Rhynchophorus spp., Rhynchophorus ferrugineus, Rhynchophorus palmarum, Scolytus spp., e.g. Scolytus multistriatus, Sinoxylon perforans, Sitophilus spp., e.g. Sitophilus granarius, Sitophilus linearis, Sitophilus oryzae, Sitophilus zeamais, Sphenophorus spp., Stegobium paniceum, Sternechus spp., e.g. Sternechus paludatus, Symphyletes spp., Tanymecus spp., e.g. Tanymecus dilaticollis, Tanymecus indicus, Tanymecus palliatus, Tenebrio molitor, Tenebrioides mauretanicus, Tribolium spp., e.g. Tribolium audax, Tribolium castaneum, Tribolium confusum, Trogoderma spp., Tychius spp., Xylotrechus spp., Zabrus spp., e.g. Zabrus tenebrioides; from the order of the Diptera, for example Aedes spp., for example Aedes aegypti, Aedes albopictus, Aedes sticticus, Aedes vexans, Agromyza spp., for example Agromyza frontella, Agromyza parvicornis, Anastrepha spp., Anopheles spp., for example Anopheles quadrimaculatus, Anopheles gambiae, Asphondylia spp., Bactrocera spp., for example Bactrocera cucurbitae, Bactrocera dorsalis, Bactrocera oleae, Bibio hortulanus, Calliphora erythrocephala, Calliphora vicina, Ceratitis capitata, Chironomus spp., Chrysomya spp., Chrysops spp., Chrysozona pluvialis, Cochliomya spp., Contarinia spp., for example Contarinia johnsoni, Contarinia nasturtii, Contarinia pyrivora, Contarinia schulzi, Contarinia sorghicola, Contarinia tritici, Cordylobia anthropophaga, Cricotopus sylvestris, Culex spp., for example Culex pipiens, Culex quinquefasciatus, Culicoides spp., Culiseta spp., Cuterebra spp., Dacus oleae, Dasineura spp., for example Dasineura brassicae, Delia spp., for example Delia antiqua, Delia coarctata, Delia florilega, Delia platura, Delia radicum, Dermatobia hominis, Drosophila spp., for example Drosphila melanogaster, Drosophila suzukii, Echinocnemus spp., Euleia heraclei, Fannia spp., Gasterophilus spp., Glossina spp., Haematopota spp., Hydrellia spp., Hydrellia griseola, Hylemya spp., Hippobosca spp., Hypoderma spp., Liriomyza spp., for example Liriomyza brassicae, Liriomyza huidobrensis, Liriomyza sativae, Lucilia spp., for example Lucilia cuprina, Lutzomyia spp., Mansonia spp., Musca spp., for example Musca domestica, Musca domestica vicina, Oestrus spp., Oscinella frit, Paratanytarsus spp., Paralauterborniella subcincta, Pegomya or Pegomyia spp., for example Pegomya betae, Pegomya hyoscyami, Pegomya rubivora, Phlebotomus spp., Phorbia spp., Phormia spp., Piophila casei, Platyparea poeciloptera, Prodiplosis spp., Psila rosae, Rhagoletis spp., for example Rhagoletis cingulata, Rhagoletis completa, Rhagoletis fausta, Rhagoletis indifferens, Rhagoletis mendax, Rhagoletis pomonella, Sarcophaga spp., Simulium spp., for example Simulium meridionale, Stomoxys spp., Tabanus spp., Tetanops spp., Tipula spp., for example Tipula paludosa, Tipula simplex, Toxotrypana curvicauda; from the order of the Hemiptera, for example Acizzia acaciaebaileyanae, Acizzia dodonaeae, Acizzia uncatoides, Acrida turrita, Acyrthosipon spp., e.g. Acyrthosiphon pisum, Acrogonia spp., Aeneolamia spp., Agonoscena spp., Aleurocanthus spp., Aleyrodes proletella, Aleurolobus barodensis, Aleurothrixus floccosus, Allocaridara malayensis, Amrasca spp., e.g. Amrasca bigutulla, Amrasca devastans, Anuraphis cardui, Aonidiella spp., e.g. Aonidiella aurantii, Aonidiella citrina, Aonidiella inornata, Aphanostigma piri, Aphis spp., e.g. Aphis citricola, Aphis craccivora, Aphis fabae, Aphis forbesi, Aphis glycines, Aphis gossypii, Aphis hederae, Aphis illinoisensis, Aphis middletoni, Aphis nasturtii, Aphis nerii, Aphis pomi, Aphis spiraecola, Aphis viburniphila, Arboridia apicalis, Arytainilla spp., Aspidiella spp., Aspidiotus spp., e.g. Aspidiotus nerii, Atanus spp., Aulacorthum solani, Bemisia tabaci, Blastopsylla occidentalis, Boreioglycaspis melaleucae, Brachycaudus helichrysi, Brachycolus spp., Brevicoryne brassicae, Cacopsylla spp., e.g. Cacopsylla pyricola, Calligypona marginata, Capulinia spp., Carneocephala fulgida, Ceratovacuna lanigera, Cercopidae, Ceroplastes spp., Chaetosiphon fragaefolii, Chionaspis tegalensis, Chlorita onukii, Chondracris rosea, Chromaphis juglandicola, Chrysomphalus aonidum, Chrysomphalus ficus, Cicadulina mbila, Coccomytilus halli, Coccus spp., e.g. Coccus hesperidum, Coccus longulus, Coccus pseudomagnoliarum, Coccus viridis, Cryptomyzus ribis, Cryptoneossa spp., Ctenarytaina spp., Dalbulus spp., Dialeurodes chittendeni, Dialeurodes citri, Diaphorina citri, Diaspis spp., Diuraphis spp., Doralis spp., Drosicha spp., Dysaphis spp., e.g. Dysaphis apiifolia, Dysaphis plantaginea, Dysaphis tulipae, Dysmicoccus spp., Empoasca spp., e.g. Empoasca abrupta, Empoasca fabae, Empoasca maligna, Empoasca solana, Empoasca stevensi, Eriosoma spp., e.g. Eriosoma americanum, Eriosoma lanigerum, Eriosoma pyricola, Erythroneura spp., Eucalyptolyma spp., Euphyllura spp., Euscelis bilobatus, Ferrisia spp., Fiorinia spp., Furcaspis oceanica, Geococcus coffeae, Glycaspis spp., Heteropsylla cubana, Heteropsylla spinulosa, Homalodisca coagulata, Hyalopterus arundinis, Hyalopterus pruni, Icerya spp., e.g. Icerya purchasi, Idiocerus spp., Idioscopus spp., Laodelphax striatellus, Lecanium spp., e.g. Lecanium corni (=Parthenolecanium corni), Lepidosaphes spp., e.g. Lepidosaphes ulmi, Lipaphis erysimi, Lopholeucaspis japonica, Lycorma delicatula, Macrosiphum spp., e.g. Macrosiphum euphorbiae, Macrosiphum lilii, Macrosiphum rosae, Macrosteles facifrons, Mahanarva spp., Melanaphis sacchari, Metcalfiella spp., Metcalfa pruinosa, Metopolophium dirhodum, Monellia costalis, Monelliopsis pecanis, Myzus spp., e.g. Myzus ascalonicus, Myzus cerasi, Myzus ligustri, Myzus ornatus, Myzus persicae, Myzus nicotianae, Nasonovia ribisnigri, Neomaskellia spp., Nephotettix spp., e.g. Nephotettix cincticeps, Nephotettix nigropictus, Nettigoniclla spectra, Nilaparvata lugens, Oncometopia spp., Orthezia praelonga, Oxya chinensis, Pachypsylla spp., Parabemisia myricae, Paratrioza spp., e.g. Paratrioza cockerelli, Parlatoria spp., Pemphigus spp., e.g. Pemphigus bursarius, Pemphigus populivenae, Peregrinus maidis, Perkinsiella spp., Phenacoccus spp., e.g. Phenacoccus madeirensis, Phloeomyzus passerinii, Phorodon humuli, Phylloxera spp., e.g. Phylloxera devastatrix, Phylloxera notabilis, Pinnaspis aspidistrae, Planococcus spp., e.g. Planococcus citri, Prosopidopsylla flava, Protopulvinaria pyriformis, Pseudaulacaspis pentagona, Pseudococcus spp., e.g. Pseudococcus calceolariae, Pseudococcus comstocki, Pseudococcus longispinus, Pseudococcus maritimus, Pseudococcus viburni, Psyllopsis spp., Psylla spp., e.g. Psylla buxi, Psylla mali, Psylla pyri, Pteromalus spp., Pulvinaria spp., Pyrilla spp., Quadraspidiotus spp., e.g. Quadraspidiotus juglansregiae, Quadraspidiotus ostreaeformis, Quadraspidiotus perniciosus, Quesada gigas, Rastrococcus spp., Rhopalosiphum spp., e.g. Rhopalosiphum maidis, Rhopalosiphum oxyacanthae, Rhopalosiphum padi, Rhopalosiphum rufiabdominale, Saissetia spp., e.g. Saissetia coffeae, Saissetia miranda, Saissetia neglecta, Saissetia oleae, Scaphoideus titanus, Schizaphis graminum, Selenaspidus articulatus, Sipha flava, Sitobion avenae, Sogata spp., Sogatella furcifera, Sogatodes spp., Stictocephala festina, Siphoninus phillyreae, Tenalaphara malayensis, Tetragonocephela spp., Tinocallis caryaefoliae, Tomaspis spp., Toxoptera spp., e.g. Toxoptera aurantii, Toxoptera citricidus, Trialeurodes vaporariorum, Trioza spp., e.g. Trioza diospyri, Typhlocyba spp., Unaspis spp., Viteus vitifolii, Zygina spp.; from the suborder of the Heteroptera, for example Aelia spp., Anasa tristis, Antestiopsis spp., Boisea spp., Blissus spp., Calocoris spp., Campylomma livida, Cavelerius spp., Cimex spp., e.g. Cimex adjunctus, Cimex hemipterus, Cimex lectularius, Cimex pilosellus, Collaria spp., Creontiades dilutus, Dasynus piperis, Dichelops furcatus, Diconocoris hewetti, Dysdercus spp., Euschistus spp., e.g. Euschistus heros, Euschistus servus, Euschistus tristigmus, Euschistus variolarius, Eurydema spp., Eurygaster spp., Halyomorpha halys, Heliopeltis spp., Horcias nobilellus, Leptocorisa spp., Leptocorisa varicornis, Leptoglossus occidentalis, Leptoglossus phyllopus, Lygocoris spp., e.g. Lygocoris pabulinus, Lygus spp., e.g. Lygus elisus, Lygus hesperus, Lygus lineolaris, Macropes excavatus, Megacopta cribraria, Miridae, Monalonion atratum, Nezara spp., e.g. Nezara viridula, Nysius spp., Oebalus spp., Pentomidae, Piesma quadrata, Piezodorus spp., e.g. Piezodorus guildinii, Psallus spp., Pseudacysta persea, Rhodnius spp., Sahlbergella singularis, Scaptocoris castanea, Scotinophora spp., Stephanitis nashi, Tibraca spp., Triatoma spp.;

from the order of the Hymenoptera, for example Acromyrmex spp., Athalia spp., e.g. Athalia rosae, Atta spp., Camponotus spp., Dolichovespula spp., Diprion spp., e.g. Diprion similis, Hoplocampa spp., e.g. Hoplocampa cookei, Hoplocampa testudinea, Lasius spp., Linepithema (Iridiomyrmex) humile, Monomorium pharaonis, Paratrechina spp., Paravespula spp., Plagiolepis spp., Sirex spp., e.g. Sirex noctilio, Solenopsis invicta, Tapinoma spp., Technomyrmex albipes, Urocerus spp., Vespa spp., e.g. Vespa crabro, Wasmannia auropunctata, Xeris spp.;

from the order of the Isopoda, for example Armadillidium vulgare, Oniscus asellus, Porcellio scaber;

from the order of the Isoptera, for example Coptotermes spp., e.g. Coptotermes formosanus, Cornitermes cumulans, Cryptotermes spp., Incisitermes spp., Kalotermes spp., Microtermes obesi, Nasutitermes spp., Odontotermes spp., Porotermes spp., Reticulitermes spp., e.g. Reticulitermes flavipes, Reticulitermes hesperus;

from the order of the Lepidoptera, for example Achroia grisella, Acronicta major, Adoxophyes spp., e.g. Adoxophyes orana, Aedia leucomelas, Agrotis spp., e.g. Agrotis segetum, Agrotis ipsilon, Alabama spp., e.g. Alabama argillacea, Amyelois transitella, Anarsia spp., Anticarsia spp., e.g. Anticarsia gemmatalis, Argyroploce spp., Autographa spp., Barathra brassicae, Blastodacna atra, Borbo cinnara, Bucculatrix thurberiella, Bupalus piniarius, Busseola spp., Cacoecia spp., Caloptilia theivora, Capua reticulana, Carpocapsa pomonella, Carposina niponensis, Cheimatobia brumata, Chilo spp., e.g. Chilo plejadellus, Chilo suppressalis, Choreutis pariana, Choristoneura spp., Chrysodeixis chalcites, Clysia ambiguella, Cnaphalocerus spp., Cnaphalocrocis medinalis, Cnephasia spp., Conopomorpha spp., Conotrachelus spp., Copitarsia spp., Cydia spp., e.g. Cydia nigricana, Cydia pomonella, Dalaca noctuides, Diaphania spp., Diparopsis spp., Diatraea saccharalis, Dioryctria spp., e.g. Dioryctria zimmermani, Earias spp., Ecdytolopha aurantium, Elasmopalpus lignosellus, Eldana saccharina, Ephestia spp., e.g. Ephestia elutella, Ephestia kuehniella, Epinotia spp., Epiphyas postvittana, Erannis spp., Erschoviella musculana, Etiella spp., Eudocima spp., Eulia spp., Eupoecilia ambiguella, Euproctis spp., e.g. Euproctis chrysorrhoea, Euxoa spp., Feltia spp., Galleria mellonella, Gracillaria spp., Grapholitha spp., e.g. Grapholita molesta, Grapholita prunivora, Hedylepta spp., Helicoverpa spp., e.g. Helicoverpa armigera, Helicoverpa zea, Heliothis spp., e.g. Heliothis virescens, Hofmannophila pseudospretella, Homoeosoma spp., Homona spp., Hyponomeuta padella, Kakivoria flavofasciata, Lampides spp., Laphygma spp., Laspeyresia molesta, Leucinodes orbonalis, Leucoptera spp., e.g. Leucoptera coffeella, Lithocolletis spp., e.g. Lithocolletis blancardella, Lithophane antennata, Lobesia spp., e.g. Lobesia botrana, Loxagrotis albicosta, Lymantria spp., e.g. Lymantria dispar, Lyonetia spp., e.g. Lyonetia clerkella, Malacosoma neustria, Maruca testulalis, Mamestra brassicae, Melanitis leda, Mocis spp., Monopis obviella, Mythimna separata, Nemapogon cloacellus, Nymphula spp., Oiketicus spp., Omphisa spp., Operophtera spp., Oria spp., Orthaga spp., Ostrinia spp., e.g. Ostrinia nubilalis, Panolis flammea, Parnara spp., Pectinophora spp., e.g. Pectinophora gossypiella, Perileucoptera spp., Phthorimaea spp., e.g. Phthorimaea operculella, Phyllocnistis citrella, Phyllonorycter spp., e.g. Phyllonorycter blancardella, Phyllonorycter crataegella, Pieris spp., e.g. Pieris rapae, Platynota stultana, Plodia interpunctella, Plusia spp., Plutella xylostella (=Plutella maculipennis), Podesia spp., e.g. Podesia syringae, Prays spp., Prodenia spp., Protoparce spp., Pseudaletia spp., e.g. Pseudaletia unipuncta, Pseudoplusia includens, Pyrausta nubilalis, Rachiplusia nu, Schoenobius spp., e.g. Schoenobius bipunctifer, Scirpophaga spp., e.g. Scirpophaga innotata, Scotia segetum, Sesamia spp., e.g. Sesamia inferens, Sparganothis spp., Spodoptera spp., e.g. Spodoptera eradiana, Spodoptera exigua, Spodoptera frugiperda, Spodoptera praefica, Stathmopoda spp., Stenoma spp., Stomopteryx subsecivella, Synanthedon spp., Tecia solanivora, Thaumetopoea spp., Thermesia gemmatalis, Tinea cloacella, Tinea pellionella, Tineola bisselliella, Tortrix spp., Trichophaga tapetzella, Trichoplusia spp., e.g. Trichoplusia ni, Tryporyza incertulas, Tuta absoluta, Virachola spp.;

from the order of the Orthoptera or Saltatoria, for example Acheta domesticus, Dichroplus spp., Gryllotalpa spp., e.g. Gryllotalpa gryllotalpa, Hieroglyphus spp., Locusta spp., e.g. Locusta migratoria, Melanoplus spp., e.g. Melanoplus devastator, Paratlanticus ussuriensis, Schistocerca gregaria;

from the order of the Phthiraptera, for example Damalinia spp., Haematopinus spp., Linognathus spp., Pediculus spp., Phylloxera vastatrix, Phthirus pubis, Trichodectes spp.;

from the order of the Thysanoptera, for example Anaphothrips obscurus, Baliothrips biformis, Chaetanaphothrips leeuweni, Drepanothrips reuteri, Enneothrips flavens, Frankliniella spp., e.g. Frankliniella fusca, Frankliniella occidentalis, Frankliniella schultzei, Frankliniella tritici, Frankliniella vaccinii, Frankliniella williamsi, Haplothrips spp., Heliothrips spp., Hercinothrips femoralis, Kakothrips spp., Rhipiphorothrips cruentatus, Scirtothrips spp., Taeniothrips cardamomi, Thrips spp., e.g. Thrips palmi, Thrips tabaci;

plant pests from the phylum of the Nematoda, i.e. plant-parasitic nematodes, in particular Aglenchus spp., for example Aglenchus agricola, Anguina spp., for example Anguina tritici, Aphelenchoides spp., for example Aphelenchoides arachidis, Aphelenchoides fragariae, Belonolaimus spp., for example Belonolaimus gracilis, Belonolaimus longicaudatus, Belonolaimus nortoni, Bursaphelenchus spp., for example Bursaphelenchus cocophilus, Bursaphelenchus eremus, Bursaphelenchus xylophilus, Cacopaurus spp., for example Cacopaurus pestis, Criconemella spp., for example Criconemella curvata, Criconemella onoensis, Criconemella ornata, Criconemella rusium, Criconemella xenoplax (=Mesocriconema xenoplax), Criconemoides spp., for example Criconemoides ferniae, Criconemoides onoense, Criconemoides ornatum, Ditylenchus spp., for example Ditylenchus dipsaci, Dolichodorus spp., Globodera spp., for example Globodera pallida, Globodera rostochiensis, Helicotylenchus spp., for example Helicotylenchus dihystera, Hemicriconemoides spp., Hemicycliophora spp., Heterodera spp., for example Heterodera avenae, Heterodera glycines, Heterodera schachtii, Hirschmaniella spp., Hoplolaimus spp., Longidorus spp., for example Longidorus africanus, Meloidogyne spp., for example Meloidogyne chitwoodi, Meloidogyne fallax, Meloidogyne hapla, Meloidogyne incognita, Meloinema spp., Nacobbus spp., Neotylenchus spp., Paralongidorus spp., Paraphelenchus spp., Paratrichodorus spp., for example Paratrichodorus minor, Paratylenchus spp., Pratylenchus spp., for example Pratylenchus penetrans, Pseudohalenchus spp., Psilenchus spp., Punctodera spp., Quinisulcius spp., Radopholus spp., for example Radopholus citrophilus, Radopholus similis, Rotylenchulus spp., Rotylenchus spp., Scutellonema spp., Subanguina spp., Trichodorus spp., for example Trichodorus obtusus, Trichodorus primitivus, Tylenchorhynchus spp., for example Tylenchorhynchus annulatus, Tylenchulus spp., for example Tylenchulus semipenetrans, Xiphinema spp., for example Xiphinema index.

Nematodes

A nematicide in crop protection, as described herein, is capable of controlling nematodes.

The term “controlling nematodes” means killing the nematodes or preventing or impeding their development or their growth or preventing or impeding their penetration into or their sucking on plant tissue.

Here, the efficacy of the compounds is determined by comparing mortalities, gall formation, cyst formation, nematode density per volume of soil, nematode density per root, number of nematode eggs per volume of soil, mobility of the nematodes between a plant or plant part treated with the compound of the formula (I) or the treated soil and an untreated plant or plant part or untreated soil (100%). Preferably, the reduction achieved is 25-50% in comparison to an untreated plant, plant part or untreated soil, more preferably 51-79% and most preferably the complete kill or the complete prevention of development and growth of the nematodes by a reduction of 80 to 100% is achieved. The control of nematodes as described herein also comprises the control of proliferation of the nematodes (development of cysts and/or eggs). Compounds of the formula (I) can likewise be used to maintain the health of the plants or animals, and they can be used for the control of nematodes in a curative, preventative or systemic manner.

The person skilled in the art knows methods for determining mortalities, gall formation, cyst formation, nematode density per volume of soil, nematode density per root, number of nematode eggs per volume of soil, mobility of the nematodes.

The use of a compound of the formula (I) may keep the plant healthy and also comprises a reduction of the damage caused by nematodes and an increase of the harvest yield.

In the present context, the term “nematodes” refers to plant nematodes which comprise all nematodes which damage plants. Plant nematodes comprise phytoparasitic nematodes and soil-dwelling nematodes. The phytoparasitic nematodes include ectoparasites such as Xiphinema spp., Longidorus spp. and Trichodorus spp.; semiparasites such as Tylenchulus spp.; migratory endoparasites such as Pratylenchus spp., Radopholus spp. and Scutellonema spp.; non-migratory parasites such as Heterodera spp., Globodera spp. and Meloidogyne spp., and also stem and leaf endoparasites such as Ditylenchus spp., Aphelenchoides spp. and Hirschmaniella spp. Particularly damaging root-parasitic soil nematodes are, for example, cyst-forming nematodes of the genera Heterodera or Globodera, and/or root gall nematodes of the genus Meloidogyne. Damaging species of these genera are, for example, Meloidogyne incognita, Heterodera glycines (soya bean cyst nematode), Globodera pallida and Globodera rostochiensis (yellow potato cyst nematode), these species being controlled effectively by the compounds described in the present text. However, the use of the compounds described in the present text is by no means restricted to these genera or species, but also extends in the same manner to other nematodes.

The phytoparasitic nematodes include, for example, Anguina spp., Aphelenchoides spp., Belonoaimus spp., Bursaphelenchus spp., Ditylenchus dipsaci, Globodera spp., Heliocotylenchus spp., Heterodera spp., Longidorus spp., Meloidogyne spp., Pratylenchus spp., Radopholus similis, Rotylenchus spp., Trichodorus spp., Tylenchorhynchus spp., Tylenchulus spp., Tylenchulus semipenetrans and Xiphinema spp.

The plants listed can be treated particularly advantageously with the compositions according to the invention. The preferred ranges stated above for the suspension concentrates also apply to the treatment of these plants. Particular emphasis is given to the treatment of plants with the suspension concentrates specifically mentioned in the present text.

The invention is elucidated by the examples that follow. These should in no way be regarded as limiting.

### PREPARATION EXAMPLES

### Comparative Example

To prepare a suspension concentrate, all liquid components are first mixed with one another. In the next step, the solids are added and stirred until a homogeneous suspension is obtained. The homogeneous suspension is subjected first to a coarse and then to a fine grinding operation, so as to obtain a suspension in which 90% of the solid particles have a particle size below 10 μm. Subsequently, Kelzan® S and water are added while stirring at room temperature to attain the defined viscosity. A homogeneous suspension concentrate is obtained.

| | | |
|---|---|---|
| 49 | g | of the compound of the formula (I-2) |
| 15 | g | Soprophor ® TS 54 |
| 45 | g | Atlox ® 4913 |
| 100 | g | glycerol |
| 1 | g | citric acid |
| 1 | g | Silfoam ® SRE |
| 1.2 | g | Proxel ® GXL |
| 0.8 | g | Preventol ® D7 |
| 1.2 | g | Kelzan ® S |
| 785.8 | g | water |

### Example 1 (OD 006)

To prepare an oil-based suspension concentrate,

| | | |
|---|---|---|
| 5.7 | g | of the compound of the formula (I-2) |
| 297 | g | ammonium sulfate¹ |
| 57 | g | Tanemul 1371 A |
| 50 | g | ATLOX 4914 |
| 44 | g | Tanemul SO 70 |
| 1.5 | g | SIPERNAT 22 S |

are added while stirring at room temperature to ¹For optimal comminution of the suspension, the ammonium sulfate is precomminuted by means of an airjet mill.

| | | |
|---|---|---|
| 544.8 | g | Edenor MESU. |

After addition has ended, the mixture is stirred at room temperature for a further 10 minutes. The resultant homogeneous suspension is subjected first to a coarse and then to a fine grinding operation, so as to obtain a suspension in which 90% of the solid particles have a particle size below 7 μm.

### Example 2 (OD 012)

To prepare an oil-based suspension concentrate,

| | | |
|---|---|---|
| 11.5 | g | of the compound of the formula (I-2) |
| 245 | g | ammonium sulfate¹ |
| 58 | g | Tanemul 1371 A |
| 49 | g | ATLOX 4914 |
| 46 | g | Tanemul SO 70 |
| 2.5 | g | SIPERNAT 22 S |

are added while stirring at room temperature to

| | |
|---|---|
| 588 g | Edenor MESU. |

After addition has ended, the mixture is stirred at room temperature for a further 10 minutes. The resultant homogeneous suspension is subjected first to a coarse and then to a fine grinding operation, so as to obtain a suspension in which 90% of the solid particles have a particle size below 7 μm.

### Example 3 (OD 048)

To prepare an oil-based suspension concentrate,

| | | |
|---|---|---|
| 48 | g | of the compound of the formula (I-2) |
| 262.5 | g | ammonium sulfate¹ |
| 56.7 | g | Tanemul 1371 A |
| 52.5 | g | ATLOX 4914 |
| 48.3 | g | Tanemul SO 70 |
| 1.5 | g | SIPERNAT 22 S |

are added while stirring at room temperature to

| | |
|---|---|
| 582 g | Edenor MESU. |

gegeben. After addition has ended, the mixture is stirred at room temperature for a further 10 minutes. The resultant homogeneous suspension is subjected first to a coarse and then to a fine grinding operation, so as to obtain a suspension in which 90% of the solid particles have a particle size below 7 μm.

### Example 4 (OD 024)

To prepare an oil-based suspension concentrate,

| | | |
|---|---|---|
| 24 | g | of the compound of the formula (I-2) |
| 262.5 | g | ammonium sulfate¹ |
| 56.5 | g | Tanemul 1371 A |
| 52.5 | g | ATLOX 4914 |
| 48.3 | g | Tanemul SO 70 |
| 1.5 | g | SIPERNAT 22 S |

are added while stirring at room temperature to

| | |
|---|---|
| 605.4 g | Edenor MESU. |

After addition has ended, the mixture is stirred at room temperature for a further 10 minutes. The resultant homogeneous suspension is subjected first to a coarse and then to a fine grinding operation, so as to obtain a suspension in which 90% of the solid particles have a particle size below 7 μm.

### Example 5 (OD 024)

To prepare an oil-based suspension concentrate,

| | | |
|---|---|---|
| 24 | g | of the compound of the formula (I-2) |
| 200 | g | diammonium hydrogenphosphate¹ |
| 90 | g | RHODAFAC MB |
| 60 | g | RHODACAL 60 BE |
| 40 | g | LUCRAMUL SO 21 |
| 15 | g | SIPERNAT 22 S |
| 10 | g | MORWET D-425 |

are added while stirring at room temperature to

| | |
|---|---|
| 551 g | Phytorob 926.65. |

After addition has ended, the mixture is stirred at room temperature for a further 10 minutes. The resultant homogeneous suspension is subjected first to a coarse and then to a fine grinding operation, so as to obtain a suspension in which 90% of the solid particles have a particle size below 7 μm.

### Example 6 (OD 024)

To prepare an oil-based suspension concentrate,

| | | |
|---|---|---|
| 24 | g | of the compound of the formula (I-2) |
| 100 | g | ETOCAS 10 |
| 50 | g | ATLOX 4914 |
| 40 | g | TWEEN 85 |
| 15 | g | SIPERNAT 22 S |
| 5 | g | BORRESPERSE NA |
| 2 | g | 2,6-di-tert-butyl-4-methylphenol |

are added while stirring at room temperature to

| | |
|---|---|
| 614 g | Miglyol 812 N. |

After addition has ended, the mixture is stirred at room temperature for a further 10 minutes. The resultant homogeneous suspension is subjected first to a coarse and then to a fine grinding operation, so as to obtain a suspension in which 90% of the solid particles have a particle size below 7 μm.

| Substance | Chem. | | | Material |
|---|---|---|---|---|
| name | designation | Manufacturer | CAS No. | type |
| Soprophor ® | Ethoxylated | Solvay | 104376-75-2 | Nonionic |
| TS 54 | Tristyrylphenol | | | surfactant |
| Atlox ® 4913 | Ethoxylated | Croda | 119724-54-8 | Nonionic |
| | polymethacrylate | | | polymer |
| | graft polymer | | | |
| Glycerol | Glycerol | various | 56-81-5 | Antifreeze |
| Citric acid | Citric acid | various | 77-92-9 | |
| Silfoam ® SRE | Polydimethylsiloxane | Wacker | 69011-36-5 | Defoamer |
| | preparation | | | |
| Proxel ® GXL | Aqueous dipropylene | Arch | 2634-33-5 | Biocide |
| | glycol solution of ~20% | Chemical | | |
| | 1,2-benzisothiazolin-3-one | | | |
| | as sodium salt | | | |
| Preventol ® D7 | 1.5% mix of | LanXess | 55965-84-9 | Biocide |
| | 5-chloro-2-methyl-4- | | | |
| | isothiazolin-3-one and | | | |
| | 2-methyl-4-isothiazolin- | | | |
| | 3-one | | | |
| Kelzan ® S | Xanthan Gum | CP Kelco | 11138-66-2 | Thickener |
| Tanemul 1371 A | Calcium | Levaco | 26264-06-2 | Anionic |
| | dodecylbenzenesulfonate | (Tanatex) | | surfactant |
| | (CaDBS) in n-butanol | | | |
| ATLOX 4914 | ethoxylated nonionic | Croda | n/a | Nonionic |
| | random polymer | | | surfactant |
| Tanemul SO 70; | Ethoxylated soybean oil; | Levaco | 61791-23-9 | Nonionic |
| Lucramul SO21 | fatty acid polyethylene | (Tanatex) | | surfactant |
| | glycol ether ester | | | |
| SIPERNAT 22 S | Precipitated amorphous | Evonik | 112926-00-8 | Thickener |
| | silica | | | |
| Edenor MESU; | Fatty acids, C16-18 and | various | 67762-38-3 | Oil |
| Phytorob | C18-unsaturated, Me | | | |
| 926.65 | esters | | | |
| RHODACAL | Calcium | Solvay | 26264-06-2 | Anionic |
| 60 BE | dodecylbenzenesulfonate | | | surfactant |
| | (CaDBS) in 2-ethylhexanol | | | |
| MORWET | naphthalenesulfonate | Akzo | 9008-63-3; | Anionic |
| D-425 | formaldehyde condensate | Nobel | 68425-94-5 | surfactant |
| | sodium salt | | | |
| RHODAFAC | Tridecyl alcohol | Solvay | 9046-01-9 | Nonionic |
| MB | ethoxylate phosphate 3EO | | | surfactant |
| ETOCAS 10 | Castor oil, ethoxylated, | Akzo | 61791-12-6 | Nonionic |
| | 10EO | Nobel | | surfactant |
| Miglyol | Caprylic/capric | Sasol | 65381-09-1; | Oil |
| 812 N | triglycerides (C8/10) | | 73398-61-5 | |
| TWEEN 85 | SORBITAN TRIOLEATE | Croda | 9005-70-3 | Nonionic |
| | 20 EO | | | surfactant |
| BORRESPERSE | Lignosulfonic acid, | Borregaard | 8061-51-6 | Anionic |
| NA | sodium salt | | | surfactant |

### BIOLOGICAL EXAMPLES

### Example 1

Myzus persicae Test (MYZUPE Translaminar)

To prepare an appropriate application solution, 1 part by weight of formulation is mixed with water to the desired concentration. In the event that addition of ammonium salts or ammonium salts and penetrants is required, these are each pipetted into the final preparation solution at a concentration of 1000 ppm after dilution.

One-leaved bell pepper plants (Capsicum annuum) heavily infested by the green peach aphid (Myzus persicae) are treated by spraying the top side of the leaf with the active ingredient formulation in the desired concentration.

After the desired time, the kill in % is determined. 100% means that all the animals have been killed; 0% means that no animals have been killed.

In this test, for example, the following compounds from the preparation examples show good efficacy at an application rate of 100 L/ha:

| | | | % kill rate |
|---|---|---|---|
| | | Animal | 2 d after |
| Active ingredient | g a.i./ha | species | application |
| Ex. (I-2) | 12 | MYZUPE | 55 |
| SC 050 + RME + AMS | 6 | MYZUPE | 40 |
| Ex. (I-2) | 12 | MYZUPE | 65 |
| OD 006 | 6 | MYZUPE | 60 |

### Example 2

Aphis gossypii Test (APHIGO Translaminar)

To prepare an appropriate application solution, 1 part by weight of formulation is mixed with water to the desired concentration. In the event that addition of ammonium salts or ammonium salts and penetrants is required, these are each pipetted into the final preparation solution at a concentration of 1000 ppm after dilution.

One-leaved cotton plants (Gossypium hirsutum) heavily infested by the cotton aphid (Aphis gossypii) are treated by spraying the top side of the leaf with the active ingredient formulation in the desired concentration.

After the desired time, the kill in % is determined. 100% means that all the animals have been killed; 0% means that no animals have been killed.

In this test, for example, the following compounds from the preparation examples show good efficacy at an application rate of 300 L/ha:

| | | | % kill rate |
|---|---|---|---|
| | | Animal | 7 d after |
| Active ingredient | g a.i./ha | species | application |
| Ex. (I-2) | 3 | APHIGO | 90 |
| SC 050 + RME + AMS | 1.5 | APHIGO | 85 |
| | 0.75 | APHIGO | 60 |
| Ex. (I-2) | 3 | APHIGO | 98 |
| OD 006 | 1.5 | APHIGO | 93 |
| | 0.75 | APHIGO | 80 |

RME = rapeseed oil methyl ester
AMS = ammonium sulfate

### Example 3

About 10 m² aubergine plots (about 40 cm in size) are treated for Bemisia tabaci in triplicate. Application is effected with a compressed air-operated backpack sprayer. The active ingredient from example (I-2) as OD 012 is tested here in the specified application rates in comparison with an SC 050 which is deployed in a tankmix with 0.1% a.i. rapeseed oil methyl ester (500 EW) and 0.1% a.i. ammonium sulfate. The water application rate is 750 L/ha.

Evaluation is effected 1, 7, 14 and 21 days by counting the living animals. Subsequently, efficacy in percent is calculated according to Henderson and Tilton.

Active

| ingredient | | | | | |
|---|---|---|---|---|---|
| (I-2) | Application rate | Efficacy (% H + T) | | | |
| Formulation | (g) a.i./ha | 1 d | 7 d | 14 d | 21 d |
| SC 050 | 12 | 60 | 81.9 | 100 | 78.3 |
| OD 012 | 12 | 62.2 | 92.2 | 100 | 80.7 |

### Example 4

Cabbage plots of about 10 m² in size are treated for Myzus persicae in quadruplicate. Application is effected with a compressed air-operated backpack sprayer. The active ingredient from example (I-2) as OD 012 is tested here in the specified application rates in comparison with an SC 050 which is deployed in a tankmix with 0.1% a.i. rapeseed oil methyl ester (500 EW) and 0.1% a.i. ammonium sulfate. The water application rate is 750 L/ha.

Evaluation is effected 3, 5, 7, 10 and 15 days after treatment by scoring the animal kill rate on the leaves.

| Active | | | | | | |
|---|---|---|---|---|---|---|
| ingredient | | | | | | |
| (I-2) | Application rate | Efficacy (% Abbott) | | | | |
| Formulation | (g) a.i./ha | 3 d | 5 d | 7 d | 10 d | 15 d |
| SC 050 | 6 | 66 | 83 | 82 | 95 | 100 |
| OD 012 | 6 | 81 | 88 | 99 | 100 | 100 |

### Example 5

Cabbage plots of about 10 m² in size are treated for Brevicoryne brassicae in triplicate. Application is effected with a compressed air-operated backpack sprayer. The active ingredient from example (I-2) as OD 012 is tested here in the specified application rates in comparison with an SC 050 which is deployed in a tankmix with 0.1% a.i. rapeseed oil methyl ester (500 EW) and 0.1% a.i. ammonium sulfate. Two applications are made with an interval of 14 days at a water application rate of 500 L/ha.

Evaluation is effected 7, 14 and 21 days after the second treatment by scoring the animal kill rate on the leaves.

| Active | | | | |
|---|---|---|---|---|
| ingredient | | | | |
| (I-2) | Application rate | Efficacy (% Abbott) | | |
| Formulation | (g) a.i./ha | 7 d | 14 d | 21 d |
| SC 050 | 12 | 93 | 85 | 100 |
| OD 012 | 12 | 100 | 90 | 100 |

1. An oil-based suspension concentrate comprising at least one room temperature-solid compound of formula (I) 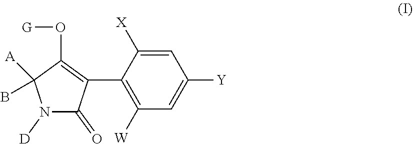
in which
W and Y are independently hydrogen, C₁-C₄-alkyl, chlorine, bromine, iodine or fluorine,
X is C₁-C₄-alkyl, C₁-C₄-alkoxy, chlorine, bromine or iodine, D is hydrogen or methyl,
A, B and the carbon atom to which A, B are bonded are C₃-C₆-cycloalkyl in which one ring member has optionally been replaced by nitrogen and which is optionally monosubstituted by C₁-C₄-alkoxy,
A, B and the carbon atom to which they are bonded are C₃-C₆-cycloalkyl substituted by an optionally C₁-C₄-alkyl- or C₁-C₄-alkoxy-C₁-C₂-alkyl-substituted alkylenedioxy group that forms a 5-membered or 6-membered ketal together with the carbon atom to which it is bonded,
G is hydrogen (a) or is one of the groups 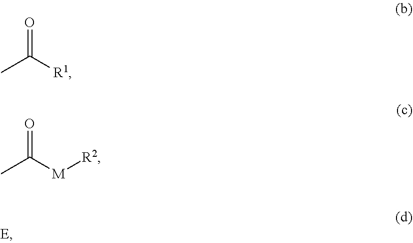
in which
E is a metal ion or an ammonium ion,
M is oxygen or sulfur,
R¹ is straight-chain or branched C₁-C₆-alkyl,
R² is straight-chain or branched C₁-C₆-alkyl
and
at least one suspended ammonium salt of formula (1) 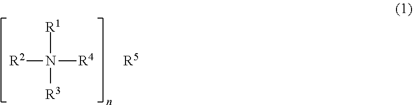
in which
R¹, R², R³ and R⁴ are independently hydrogen or in each case optionally mono- or polysubstituted C₁-C₈-alkyl or C₁-C₈-alkylene, where the substituents may be selected from halogen, nitro and cyano,
n is 1, 2 or 3,
R⁵ is hydrogencarbonate, tetraborate, fluoride, bromide, iodide, chloride, monohydrogenphosphate, dihydrogenphosphate, hydrogensulfate, tartrate, sulfate, nitrate, thiosulfate, thiocyanate, formate, lactate, acetate, propionate, butyrate, pentanoate, citrate, oxalate, carbonate, pentaborate, sulfite, benzoate, hydrogenoxalate, hydrogencitrate, methylsulfate or tetrafluoroborate,
at least one mineral oil, vegetable oil, fatty acid triglyceride or fatty acid alkyl ester,
at least one nonionic surfactant and/or at least one anionic surfactant, optionally an uptake promoter, and
optionally one or more additives from the groups of the spreaders, the foam inhibitors, the antioxidants, the dyes and/or the thickeners.

2. The oil-based suspension concentrate as claimed in claim 1, wherein
W is methyl,
X is chlorine or methyl,
Y is chlorine, bromine or methyl,
D is hydrogen,
A, B and the carbon atom to which they are bonded are saturated C₆-cycloalkyl substituted by an alkylenedioxy group that forms a 5-membered or 6-membered ketal together with the carbon atom to which it is bonded,
G is hydrogen (a) or is one of the groups 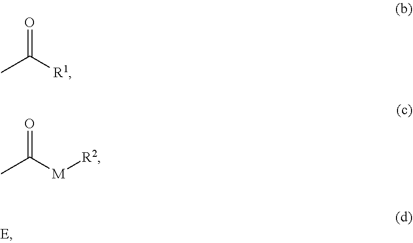
in which
M is oxygen,
E is one metal ion equivalent or an ammonium ion,
R¹ is straight-chain or branched C₁-C₄-alkyl,
R¹ is straight-chain or branched C₁-C₄-alkyl.

3. The oil-based suspension concentrate as claimed in claim 1, wherein the substituents W, X, Y, A, B, D and G have the definitions given in the table:
(I)

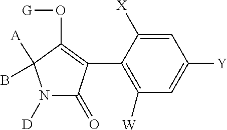

| | | | | | | |
|---|---|---|---|---|---|---|
| W | X | Y | A | B | G | D |
| | | | | | |
|---|---|---|---|---|---|
| CH₃ | CH₃ | CH₃ | 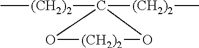 | H | H |
| CH₃ | CH₃ | Cl | 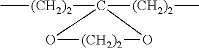 | H | H |
| CH₃ | CH₃ | Br | 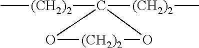 | H | H |
| CH₃ | CH₃ | CH₃ | 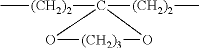 | H | H |
| CH₃ | CH₃ | Cl | 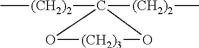 | H | H |
| CH₃ | CH₃ | Br | 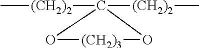 | H | H |

4. The oil-based suspension concentrate as claimed in claim 1, wherein the compound of formula (I) has the following structure:

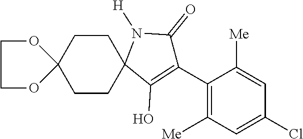 [SMILES: Cc1cc(Cl)cc(C)c1C1=C(O)C2(CCC3(CC2)OCCO3)NC1=O]

5. A process for producing the suspension concentrate as claimed in claim 1, comprising mixing
at least one room temperature-solid compound of formula (I),
at least one ammonium salt of formula (1),
at least one mineral oil, vegetable oil, fatty acid triglyceride or fatty acid alkyl ester,
at least one nonionic surfactant and/or at least one anionic surfactant,
optionally an uptake promoter, and
optionally one or more additives from the groups of the spreaders, the foam inhibitors, the antioxidants, the dyes and/or the thickeners
with one another, and then optionally grinding the resulting suspension.

6. The suspension concentrate as claimed in claim 1, wherein the ammonium salt of formula (1) used is ammonium sulfate.

7. The suspension concentrate as claimed in claim 1, wherein the ammonium salt of formula (1) used is diammonium monohydrogenphosphate.

8. The suspension concentrate as claimed in claim 1, wherein rapeseed oil methyl ester is present.

9. The suspension concentrate as claimed in claim 1, wherein caprylic acid/capric acid triglyceride is present.

10. The suspension concentrate as claimed in claim 1, wherein the uptake promoter present is at least one alkanol alkoxylate of formula
R—O—(-AO)ₘ₋R′ (II)
in which
R is straight-chain or branched alkyl having 4 to 20 carbon atoms,
R′ is hydrogen, methyl, ethyl, n-propyl, isopropyl, n-butyl, isobutyl, t-butyl, n-pentyl or n-hexyl,
AO represents an ethylene oxide radical, a propylene oxide radical, a butylene oxide radical or mixtures of ethylene oxide and propylene oxide radicals or butylene oxide radicals and
m represents numbers from 2 to 30.

11. The suspension concentrate as claimed in claim 1, wherein the content
of compound of formula (I) is between 0.5% and 20% by weight,
of ammonium salt of formula (1) is between 5-35% by weight,
of oil is between 20-75% by weight,
of nonionic surfactant and/or anionic surfactant is 1-25% by weight,
of uptake promoter is between 0-25% by weight,
of additives is between 0-10% by weight.

12. A product comprising one or more suspension concentrates as claimed in claim 1 for application of the compounds of formula (I) present to one or more plants and/or a habitat thereof.

13. A product comprising one or more suspension concentrates as claimed in claim 1 for control of insects.

14. A composition comprising a content of a suspension concentrate as claimed in claim 1 and one or more extenders and/or surface-active reagents.
